(19) United States
(12) Patent Application Publication
(10) Pub. No.: US 2007/0047243 A1
(43) Pub. Date: Mar. 1, 2007

(54) Mounting structure for LED lighting systems

(76) Inventors: Christian Hacker, Treviso (IT); Alessandro Maschietto, Paese (IT); Giovanni Scilla, Fontane di Villorba (IT); Alessandro Scordino, Mestre (IT)

Correspondence Address: OSRAM SYLVANIA INC, 100 ENDICOTT STREET, DANVERS, MA, 01923, US

(21) Appl. No.: 11/510,741

(22) Filed: Aug. 28, 2006

(30) Foreign Application Priority Data
Aug. 29, 2005 (EP) 05425602

(51) Int. Cl. F21V 19/00

(52) U.S. Cl. 362/382

(57) ABSTRACT

A mounting structure for LED lighting sources, includes a support body having attached on one side thereof a circuit board for mounting the LED lighting sources. The circuit board is preferably a printed-circuit board with conductive traces to feed electrical power to the LED lighting sources. The support body is in the form of an elongated bar or a box with a linear, round, square, hexagonal or octagonal shape. The support body is a drawn or molded body of a lightweight material and preferably exhibits good heat transfer properties. The support body includes a back side for mounting the structure on a supporting surface, such back side possibly having associated a heat dissipation fixture. Additionally, the support body may have free space inside and/or be at least partially apertured to permit cooling air flow for a driver circuit for driving the LED lighting source.

### FIELD OF THE INVENTION

The present invention relates to lighting systems including light emitting diodes (LEDs) as light sources.

### DESCRIPTION OF THE RELATED ART

In addition to their established use as display elements, light emitting diodes (LEDs) are becoming increasingly popular as lighting sources. This applies primarily to so-called high-flux or high-brightness LEDs.

An LED lighting system typically includes a number of components such as one or more LED light sources, a driver circuit, a heat sink, optics, connection means, ancillary mounting elements. These components require interconnections that may easily turn out to be rather complex. In view of this, present day LED lighting systems exhibit only limited possibilities of integration. For example, the driving circuits are usually implemented as a part of the power supply module.

### OBJECT AND SUMMARY OF THE INVENTION

In view of the foregoing, the need is felt for improved mounting structures for LED lighting systems that i.a. i) may permit an extensive integration of the components of an LED lighting system, ii) result in lighting systems of compact size, iii) facilitate handling, connecting and mounting of the system, and iv) facilitate maintenance and replacement of any single component.

The object of the invention is to provide a fully satisfactory response to that need.

According to the present invention, this object is achieved by means of a structure having the features set forth in the claims that follow. The claims are an integral part of the disclosure of the invention provided herein.

A preferred embodiment of the arrangement described herein is thus a mounting structure for an LED lighting system including at least one LED lighting source, the structure including (e.g. by having attached thereon) a circuit board for mounting said at least one LED lighting source, said circuit board having conductive traces to feed electrical power to said at least one LED lighting source.

### BRIEF DESCRIPTION OF THE ANNEXED DRAWINGS

The invention will now be described, by way of example only, with reference to the enclosed figures of drawing, wherein:

FIG. 1 is schematic perspective representation of a first embodiment of a LED mounting structure as described herein;

FIG. 2 is illustrative of a different geometric configuration of the structure described herein;

FIG. 3 shows the possible series mounting of a number of structures as shown in FIG. 1;

FIG. 4 shows a number of structures as shown in FIG. 1 assembled side-by side, and

FIG. 5 is a partly broken perspective side view of a portion of the structure of FIG. 1 showing in greater detail a possible arrangement of components therein.

### DETAILED DESCRIPTION OF PREFERRED EMBODIMENTS OF THE INVENTION

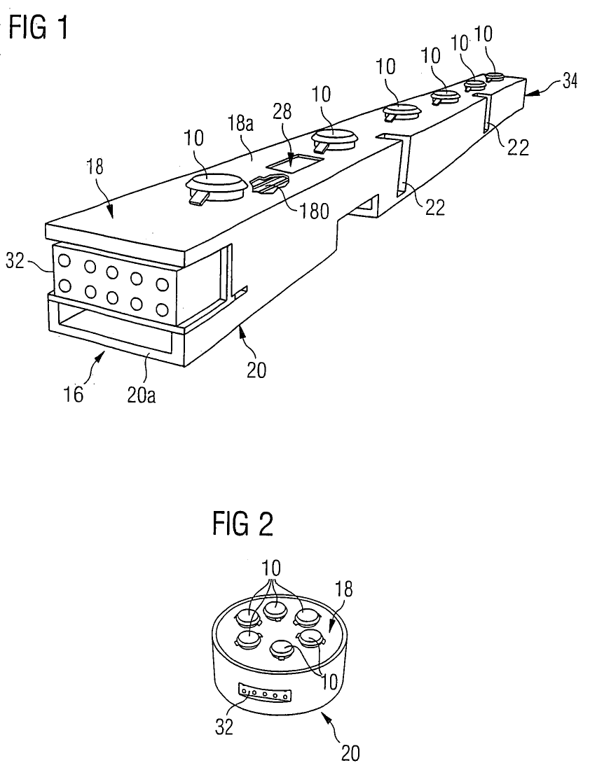

FIG. 1 is generally representative of a mounting structure for an LED lighting system including one or more LED lighting sources 10.

As illustrated herein, each of the light sources 10 includes an LED element that may be in association with a disc-like optical system to create a sort of button-like assembly. Nevertheless, any other (possibly bigger) optical system may used within the framework of the arrangement described herein, the same also applying to light sources with a fixed optical system or without any optical system at all. Such an assembly is known in the art and resorting to such an assembly is not a mandatory requirement of the invention: in fact the invention as disclosed herein is applicable to LED lighting sources having different shapes and/or included in different type of assemblies, including assemblies that do not comprise an associated optical system.

All the light sources 10 are attached to a circuit board 18a with conductive traces 180 to feed electrical power to the light sources 10. The circuit board 18a (typically a printed-circuit board or PCB) is preferably attached to the front side 18 of the support body 16. Typically, the printed circuit board 18a has the conductive traces 180 printed thereon and the light sources 10 include protruding contacts for contacting the conductive traces 180.

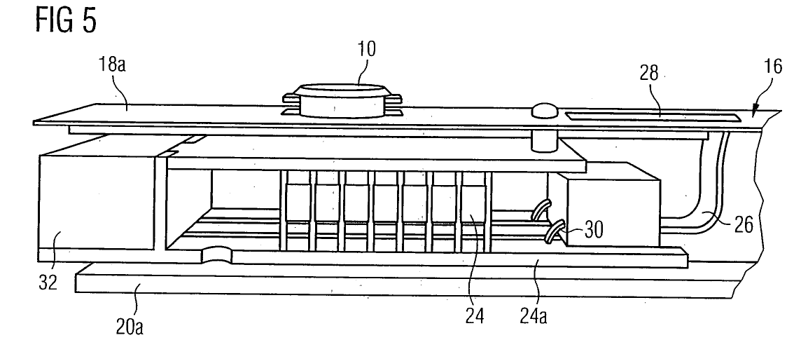

The circuit board 18a (better depicted in FIG. 5) may be of any suitable material (e.g. FR4, CEM, PI) to ensure electrical connection to the light sources 10 via the traces 180 and electrical isolation to the body 16. A preferable material also offers a good heat transfer to the body 16. Therefore glued or screwed circuit boards 18a are preferred to ensure a good thermal connection to the body 16. Production of the circuit board 18 is in accordance with state of the art technologies. The upper surface is preferably protected from direct exposure to the outside by a coating or covering such as e.g. a paint layer, a plastics foil or the like.

In the embodiment illustrated in FIG. 1, the support body 16 is in the form of an elongated, box-like, generally hollow bar having a rectangular cross section. In the alternative embodiment illustrated in FIG. 2 the support body 16 is in the form of a substantially round box. The shapes illustrated in FIGS. 1 and 2 are purely illustrative: the support body 16 may in fact be of any shape, e.g. linear, round, square, hexagonal, octagonal, and so on.

By way of example, the bar-like support body 16 illustrated in FIG. 1 may be of a parallelepiped shape overall with dimensions of e.g. 15×20×300 mm (for height, width and length, respectively).

Whatever its form, the support body 16 typically includes two opposed flat sides 18 and 20, generally parallel to each other.

The body 16 may include partially open sides to permit additional airflow for cooling purposes.

As seen in the drawing, the first side 18 is in an upper or “top” position, while the opposite side 20 forms a lower or “bottom” side of the support body 16.

In a typical mounting arrangement, the body 16 is placed inside a lighting fixture and/or attached to this fixture via the bottom side 20. For an easy handling it is preferable that the body 16 includes recessed passages 22 for mounting screws or similar retain elements.

The material comprising the support body 16 may be any material suitable for producing a body of sufficient mechanical strength. Lightweight materials such as a metal (e.g. aluminum), plastics adapted to be shaped by standard techniques (e.g. drawing, molding) are suitable for use within the framework of the invention. Materials exhibiting have a good heat transfer coefficient (e.g.: aluminum, metal-loaded plastics) represent preferred choices.

The “back” side 20 of the body 16 (opposite to the LED sources 10) may be attached to another structure 20a (e.g.: a finned fixture) to allow additional heat dissipation. In this case the other structure is working as an additional heat sink.

In order to make the structure compact, the overall dimensions of the support body 16 are preferably selected to be just enough to allow mounting on the front side 18 a PCB element 18a adapted to carry the LED sources 10 with their electrical connections, while permitting the insertion of a driver 24 having an associated driver board 24a (e.g. a PCB —see FIG. 5) within the body 16.

In a currently preferred embodiment, the driver 24 is a voltage-to-current converter. In a particularly preferred embodiment, the driver 24 includes the possibility of control single color, multi-color or dimmable operation. The driver board 24a hosts various components (of a known type) to control the drive currents of the LED sources 10.

The shape of the body 16 is designed to keep the driver board 24a at a given position by locking the board 24a to that position. The driver board 24a may thus be exchangeable. The connections between the circuit board 24a and the LED light sources 10 may include a flexible portion of the driver board or a flexible cable or ribbon-like flat wiring 26, extending from the board 24a to the PCB element 18a through an opening 28 in the body 16 (see FIG. 5).

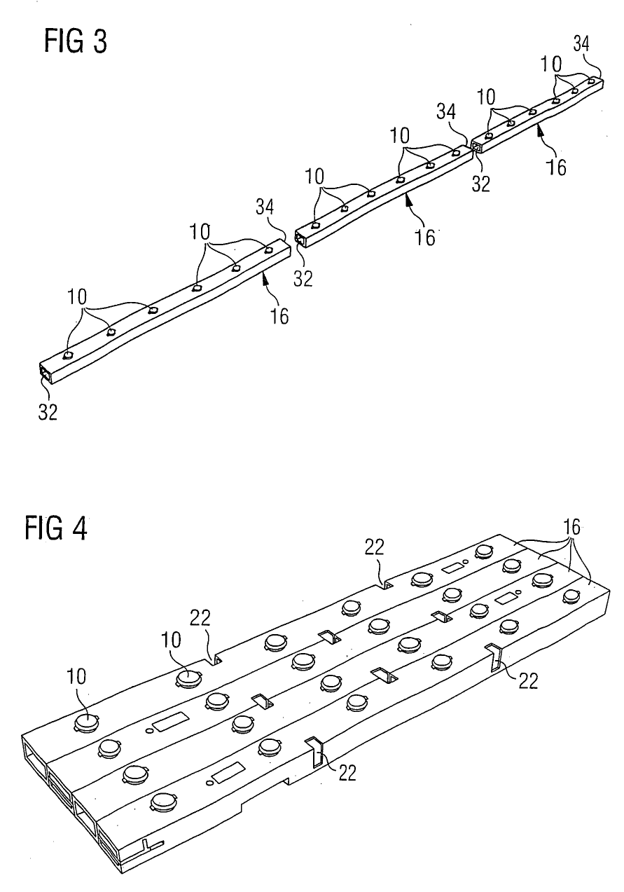

Wiring 30 may be arranged within the body 16 to allow a feed-through (i.e. cascaded) connection to one or more homologous structures. For that purpose, the driver PCB 24a may have associated connectors 32, 34 arranged at the ends of the body 16 (see e.g. FIG. 3) and adapted to permit series connection of two or more lighting structures of the kind described in the foregoing. Essentially the connector 32 and 34 are adapted to permit plug-and-socket connection by inserting the (e.g. male-type) connector 34 of one structure into a complementary (e.g. female-type) connector 32 carried by another neighboring structure.

Even in the absence of such a plug-and-socket structure, a single connector 32 as shown in FIG. 5 is adapted to permit easy connection of the driver board 24a to a power source to supply electrical power to the LED sources 10.

As an alternative to the series connection illustrated in FIG. 3, the possibility exists of chaining up two or more identical structures in a side-by-side structure as illustrated in FIG. 4. Gaps can be possibly created between neighboring structures; alternatively, two ore more structures can be grouped to form a no gap, compact structure, as shown in FIG. 5.

In either case (linear, series connection of FIG. 3; parallel, side-by-side structure of FIG. 4) a constant LED pitch can be easily ensured, without having to resort to additional tools such as e.g. mounting jigs or the like.

Consequently, without prejudice to the underlying principles of the invention, the details and the embodiments may vary, even appreciably, with reference to what has been described by way of example only, without departing from the scope of the invention as defined by the annexed claims.

1. A mounting structure for an LED lighting system including at least one LED lighting source (10), the structure including a circuit board (18a) for mounting said at least one LED lighting source (10), said circuit board (18a) having conductive traces (180) to feed electrical power to said at least one LED lighting source (10).

2. The structure of claim 1, characterized in that said circuit board (18a) is attached to a support body (16).

3. The structure of either claim 1, characterized in that said circuit board (18a) is a printed-circuit board (PCB).

4. The structure of claim 3, characterized in that said circuit board (18a) has said conductive traces (180) printed thereon.

5. The structure of claim 1, characterized in that said at least one LED lighting source (10) includes an assembly having protruding contacts for contacting said conductive traces (180).

6. The structure of claim 2, characterized in that said support body (16) is in the form of an elongated bar.

7. The structure of claim 2, characterized in that said support body (16) is in the form of a box with a shape selected out of linear, round, square, hexagonal, octagonal.

8. The structure of claim 2, characterized in that said support body (16) is a drawn or molded body.

9. The structure of claim 2, characterized in that said support body (16) is of a lightweight material.

10. The structure of claim 2, characterized in that said support body (16) is of a metal material such as aluminum.

11. The structure of 1 to 9 claim 2, characterized in that said support body (16) is of a plastics material.

12. The structure of claim 2, characterized in that said support body (16) is of a material having a good heat transfer coefficient.

13. The structure of claim 2, characterized in that said support body (16) includes passages (22) for mounting retain elements.

14. The structure of claim 2, characterized in that said support body (16) includes a back side (20) for mounting the structure on a supporting surface.

15. The structure of claim 2, characterized in that said support body (16) has coupled a heat dissipation fixture (20a).

16. The structure of claims claim 2, characterized in that said support body (16) is a hollow body having free space inside.

17. The structure of claim 2, characterized in that said support body (16) is at least partially apertured to permit cooling air flow therethrough.

18. The structure of claim 2, characterized in that said support body (16) has mounted therein a driver circuit (24) for driving said at least one LED lighting source (10).

19. The structure of claim 18, characterized in that electrical connection between said driver circuit (24) and said at least one LED lighting source (10) includes one of a flexible portion of a driver board, a flexible cable or flexible ribbon-like flat wiring (26).

20. The structure of claim 19, characterized in that said flexible electrical connection (26) extends through an opening (28) in said support body (16).

21. The structure of claim 1, characterized in that it includes connectors (32, 34) to allow cascaded connection to one or more homologous structures.

22. The structure of claim 21, characterized in that it includes said connectors (32, 34) arranged at opposite ends of said support body (16) to permit plug-and-socket connection of one connector (34, resp. 32) carried by the structure with at least another, complementary connector (32, resp. 34) carried by a neighboring structure.

23. The structure of claim 2, characterized in that said support body (16) is configured for linear series connection of a plurality of homologous structures.

24. The structure of claim 2, characterized in that said support body (16) is configured for parallel, side-by-side connection of a plurality of homologous structures

25. The structure of claim 2, characterized in that said support body (16) is configured for constant pitch mounting a plurality of said LED lighting sources (10).
